(19) United States
(12) Patent Application Publication
(10) Pub. No.: US 2016/0350639 A1
(43) Pub. Date: Dec. 1, 2016

(54) Smart Backpack

(71) Applicant: Riera Carrión Tere, San Juan, PR (US)

(72) Inventor: Riera Carrión Tere, San Juan, PR (US)

(21) Appl. No.: 15/170,621

(22) Filed: Jun. 1, 2016

Related U.S. Application Data
(60) Provisional application No. 62/169,244, filed on Jun. 1, 2015.

(51) Int. Cl. G06K 19/077; G06K 7/10; A45F 3/00

(52) U.S. Cl. CPC G06K 19/07758; A45F 3/00; G06K 7/10366

(57) ABSTRACT

A backpack comprised of color-coded compartments or dividers that are provided for storing textbooks, binders, file folders, handouts, and the like. The dividers include particular indicia and/or customizable indicia for identifying the compartments. The identification tabs can be color-coded or include identifying indicia. The backpack also includes a priority folder and an item recognition system.

### CROSS-REFERENCE TO RELATED APPLICATION

N/A

### STATEMENT REGARDING FEDERALLY SPONSORED RESEARCH AND DEVELOPMENT

N/A

### BACKGROUND OF THE INVENTION

Field of the Invention

The present invention relates to backpacks and, more particularly, to a backpack with a unique structure to organize and provide separate compartments for important items as well as additional systems and/or technologies for the tracking of internal items and general backpack usage.

Discussion of the Background

Current backpacks comprise one main compartment in which the bigger and heavier articles are stored, and at least another one or more smaller outer compartments in which smaller articles are stored. Normally, in the main compartment the bigger and heavier articles, such as books and notebooks, are stored without any means for organization. Further, users are limited in their ability to organize, recognize and group the items for each course because these items must all be stored together in the main compartment. Also, there is no specific space designated for handouts (papers/documents) that require the attention of parents and their return to school administrators/teachers. Consequently, parents have to spend several minutes locating important documents or notifications sent home by the school.

Another problem with traditional backpacks is that important papers are positioned in the backpack's main compartment wherein said handouts are easily misplaced, damaged and/or forgotten. The consequence is that students fail to perform the required task of processing the handout as per the demands of school administrators/teachers. This is particularly relevant to students in middle school and high school, who have a tendency to randomly throw documents into their backpacks throughout the school day, returning home with a collection of disorganized class papers and homework handouts.

Additionally, even if students use their backpacks compartments to their advantage, they have no indication that they are carrying the proper items for that day or if anything important is missing. They may, for example, forget to bring a book or homework assignment to class or, upon their return home, forget to bring a handout requiring their parents' attention. Furthermore, a teacher may want to notify students of particular items or notify parents that they should be expecting an item requiring their attention.

The present disclosure is directed to overcoming the one or more problems or disadvantages associated with the prior art.

### SUMMARY OF THE INVENTION

In accordance with one aspect, the present disclosure is directed towards a backpack that allows the user to organize the articles to be transported. Particularly, it is an object of the present invention to provide a backpack featuring subject matter dividers or compartments in order to readily organize various items by subject matter or class, allowing the student to more easily accommodate and retrieve class materials by individual subject matters.

According to another aspect, the present disclosure is directed to a removable subject matter divider configured or shaped in the form of steps, wherein said subject matter divider further comprises recognizable indicia including distinctive marks, colors and/or texture to assist in identifying a subject matter or class.

According to another aspect, the present disclosure provides an inner pocket assembly having flexible pockets comprising detachable or interchangeable recognizable indicia including distinctive marks. The inner pocket assembly is configured to be attached to the backpack's inner surface.

According to another aspect of the present disclosure is to provide a posture and backpack weight tracking system that enables users to maintain proper posture and monitor the weight of their backpack so as to not overburden the users back.

According to another aspect, the present disclosure is directed to a back-to-back priority pocket whose main purpose is to provide easy access to important papers/handouts and organize them in an inbox/outbox format. In accordance with the principles of the current disclosure the backpack comprises a priority pocket with an open, subdivided space for storing important papers that need easy access in order to take immediate action. The priority pocket comprises at least a slide-out sleeve including a retractable mechanism and at least a sensor electrically coupled to an indicator in order to advise users of important papers.

Another aspect of the present disclosure is to provide a computer-readable medium in communication with a transmitting device for notifying any missing item in the backpack. The computer-readable medium includes instructions for receiving information from the transmitting device in the form of a signal and advice the computer-readable medium of the missing item.

According to another aspect of the present disclosure is to provide a computer-readable medium in communication with a transmitting device for notifying any missing item in the backpack. The computer-readable medium includes instructions for receiving information from the transmitting device in the form of a signal in order to notify the computer-readable medium of the missing item.

Yet another object of the present invention is to provide a mechanism for teachers to notify students of items that should be carried for a particular day.

To enable a better understanding of the objectives and features of the present invention, a brief description of the drawing below will be followed with a detailed description of the invention.

### BRIEF DESCRIPTION OF THE DRAWINGS

FIG. 1 is a general front view of the structure of the first exemplary embodiment in accordance with the principles of the present disclosure.

FIG. 2 is a general back view of the structure of the first exemplary embodiment in accordance with the principles of the present disclosure.

FIG. 3 is an exploded drawing of the priority pocket of the first exemplary embodiment in accordance with the principles of the present disclosure.

FIG. 4 is a general view of the priority pocket with slide-out sleeve of the first exemplary embodiment in accordance with the principles of the present disclosure.

FIG. 5 is a more detailed view of the priority pocket with slide-out sleeve of the first exemplary embodiment in accordance with the principles of the present disclosure.

FIG. 6 is a more detailed view of the first slide-out sleeve mechanism of the first exemplary embodiment in accordance with the principles of the present disclosure.

FIGS. 7A-7B is a more detailed view of the second slide-out sleeve mechanism of the first exemplary embodiment in accordance with the principles of the present disclosure.

FIG. 8 is a more detailed view of the third slide-out sleeve mechanism of the first exemplary embodiment in accordance with the principles of the present disclosure

FIGS. 9A-9B show a general view of the first subject matter divider exemplary embodiment in accordance with the principles of the present disclosure.

FIGS. 10A-10B show a general view of the second subject matter divider exemplary embodiment in accordance with the principles of the present disclosure.

FIG. 11 is a general view of the detachable subject matter divider exemplary embodiment in accordance with the principles of the present disclosure.

FIGS. 12A-12B are general views of the subject matter dividers exemplary embodiment inside the backpack in accordance with the principles of the present disclosure.

FIGS. 13A-13B are general views of a flexible subject matter divider exemplary embodiment inside the backpack in accordance with the principles of the present disclosure.

FIGS. 14A-14C are general views of the exemplary embodiment for flexible dividers including interchangeable recognizable indicia in accordance with the principles of the present disclosure.

FIG. 15 is a general view of the exemplary embodiment of the subject matter divider including interchangeable recognizable indicia in accordance with the principles of the present disclosure.

FIG. 16 is a block diagram of an exemplary embodiment of the control unit of the backpack in accordance with the principles of the present disclosure.

FIG. 17 is a general view of the exemplary embodiment for the item recognition system for the priority folder in accordance with the principles of the present disclosure in accordance with the principles of the present disclosure.

FIG. 18 is a general view of the exemplary embodiment for item recognition system in communication with mobile device in accordance with the principles of the present disclosure in accordance with the principles of the present disclosure.

FIG. 19 is a general view of an exemplary embodiment of the weight indicator system and orientation detection system of the backpack in accordance with the principles of the present disclosure.

FIG. 20 is an example graphic user interface (GUI) for displaying the weight of the backpack in accordance with the principles of the present disclosure.

FIG. 21 is a general view of the exemplary embodiment for item recognition system inside dividers in accordance with the principles of the present disclosure in accordance with the principles of the present disclosure.

FIG. 22 is a general view of the exemplary embodiment for backpack features indicators in accordance with the principles of the present disclosure in accordance with the principles of the present disclosure.

FIG. 23 shows a logical flow diagram of the process of registering unique tags with a particular backpack in accordance with the principles of the present disclosure.

FIG. 24 shows a logical flow diagram of the process of scanning a backpacks interior in accordance with the principles of the present disclosure.

FIG. 25 is an example GUI for displaying the items currently found in a backpack and those missing in accordance with the principles of the present disclosure.

FIG. 26 is a diagram that depicts the logical process of a requester assigning items for backpack users to carry in accordance with the principles of the present disclosure.

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

[Physical Characteristics]

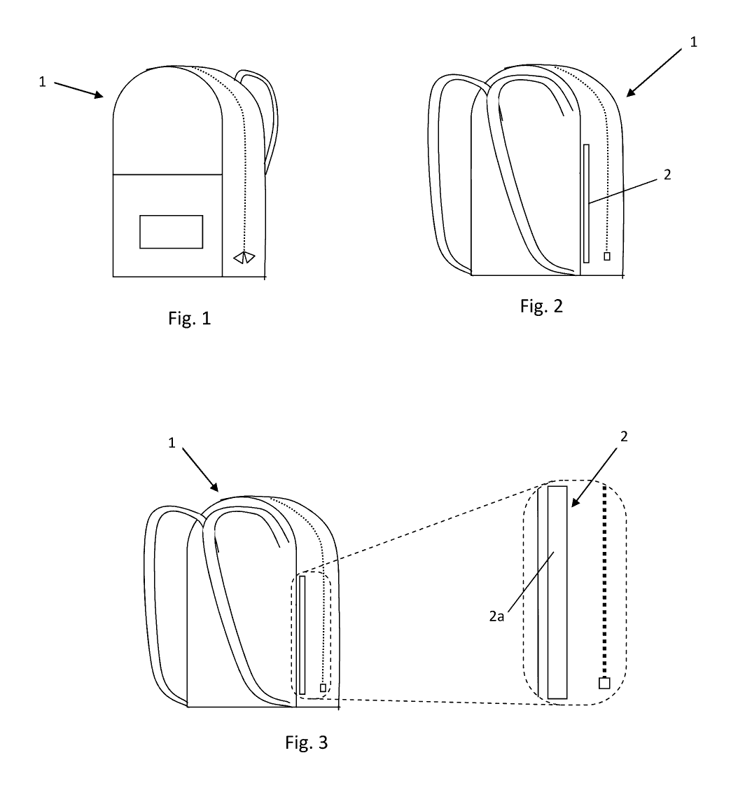

The present invention discloses several preferred physical embodiments wherein each embodiment can be made of different materials, wherein the material selection depends on where the backpack is operated, employed or used. For example, the material used includes plastic, water resistant textile, UV resistance material and more. FIG. 1 and FIG. 2 are directed to a backpack 1, which may include wheels (not shown), comprising at least a priority pocket section 2 in accordance with the principles of the current disclosure. The priority pocket 2 comprises an open space with an entrance 2a as shown in FIG. 3. The entrance is normally open, however a cover may be provided to avoid easy access to the priority pocket 2.

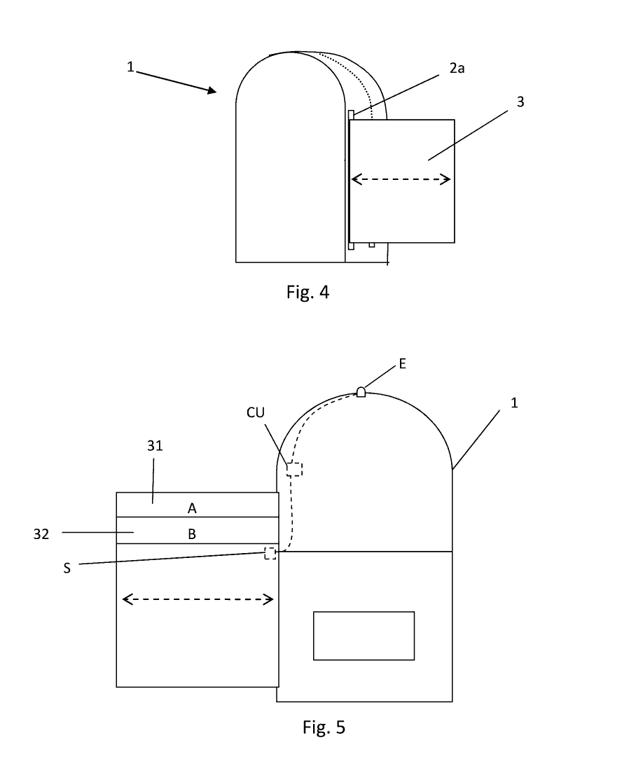

Inside said open space a slide-out sleeve 3 is located. The dimension of the open space may vary; however, said open space needs to provide enough space to at least enclose said slide-out sleeve 3 inside. The slide-out sleeve 3 is configured to slide out in order to have access to the slide-out sleeve 3 as shown in FIG. 4. As mentioned above, one of the objects of the present disclosure is to provide a priority pocket 2, wherein said priority pocket 2 provides easy access to important documents.

The slide-out sleeve 3, as shown in FIG. 5, comprises a pocket section 31, 32 with recognizable indicia and a sensor S. Each pocket section 31, 32 is provided with a space to hold documents selected by the user, more particularly documents that the user classifies as important. Further, each pocket 31, 32 is preferred to have a sensor S, wherein said sensor S is used to identify the presence of a document. The sensor S may comprise a normally closed circuit which opens in the presence of a document inside at least one of the pockets 31, 32. The normally closed circuit may activate when the selected document spaces apart the close terminals of said normally closed circuit. Subsequently when the normally closed circuit is activated an electrical signal is generated. The sensor S, which may be directly connected to a visual alert indicator or, as in the preferred embodiment, electrically connected to a control circuit CU and then redirected to a visual alert indicator, as explained in details below, alert user of the presence of a document at the priority pocket. It is preferable that said control unit receives and analyzes the signal generated by sensor S and activates or generates an alert or warning. The alert or warning may be a visual alert indicator, such as a light emitting diode E, a sound tone, or a vibration.

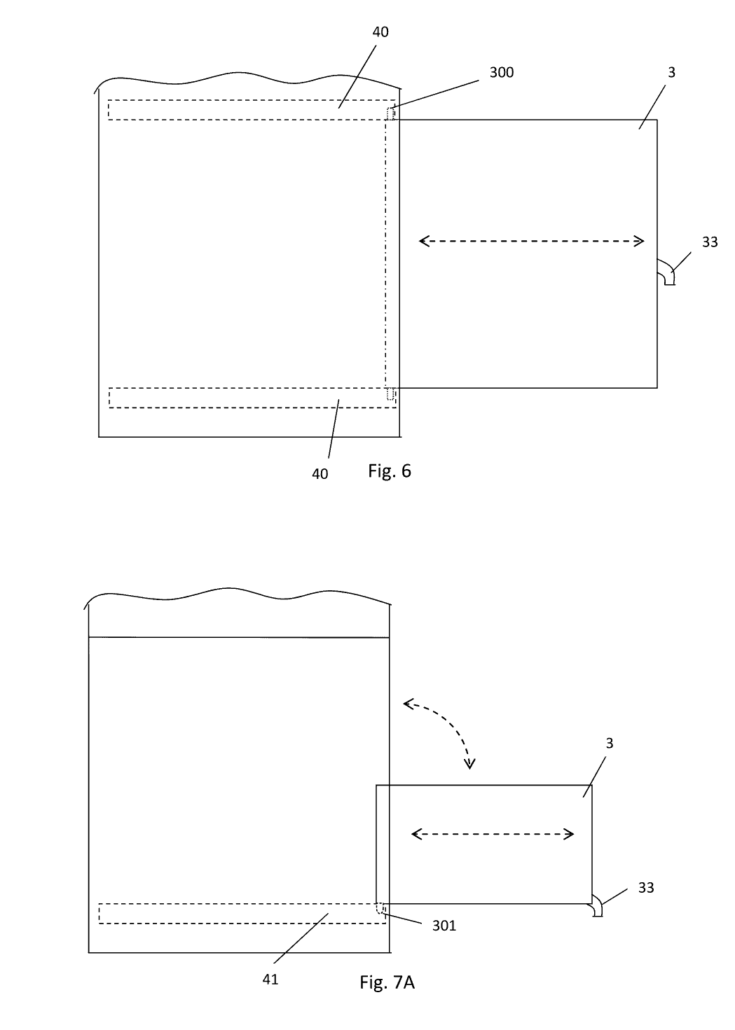

The slide-out sleeve 3 are mechanically coupled to the backpack 1 by means of a slide-out sleeve mechanism, as shown on FIG. 6 through FIG. 7B, which show at least a first and second slide-out mechanism, wherein said first slide-out sleeve mechanism comprises at least a track or guide, wherein a pin 300 attached to the slide-out sleeve 3 is inserted to limit the slide-out sleeve 3 movement. Mainly the pin moves horizontally on the track 40 and the slide-out sleeve 3 comprises a pull-band 33, wherein said pull-band 33 assists with the process of removing the slide-out sleeve 3 from the priority pocket 2.

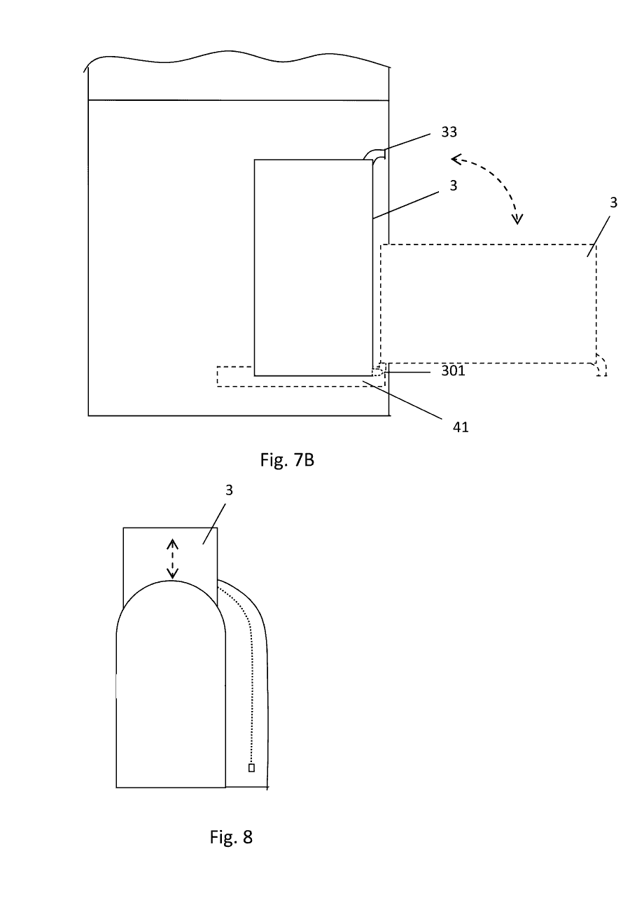

The second slide-out sleeve mechanism, such as shown in FIG. 7A through 7B, comprises a track 41 and a pin 301, wherein said pin assists with the horizontal movement and rotational movement of the slide-out sleeve 3. As disclosed above, a pull-band 33 is provided for removing the slide-out sleeve 3 from the priority pocket 2. The slide-out mechanism provides access to the priority pocket, however it is important to understand that said access or entrance 2a may be located on the sides of the back part of the backpack and/or the top part of the back part of said backpack as shown in FIG. 8.

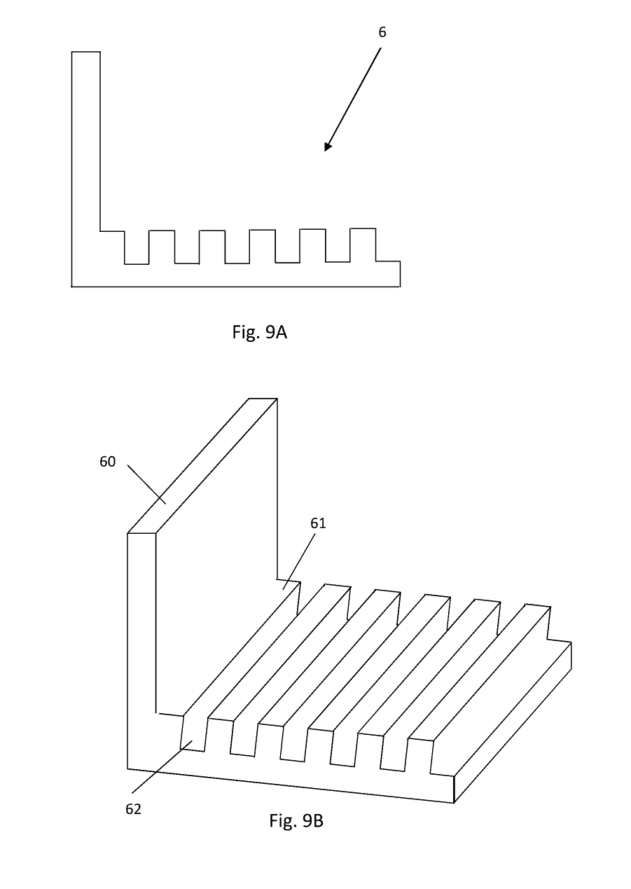

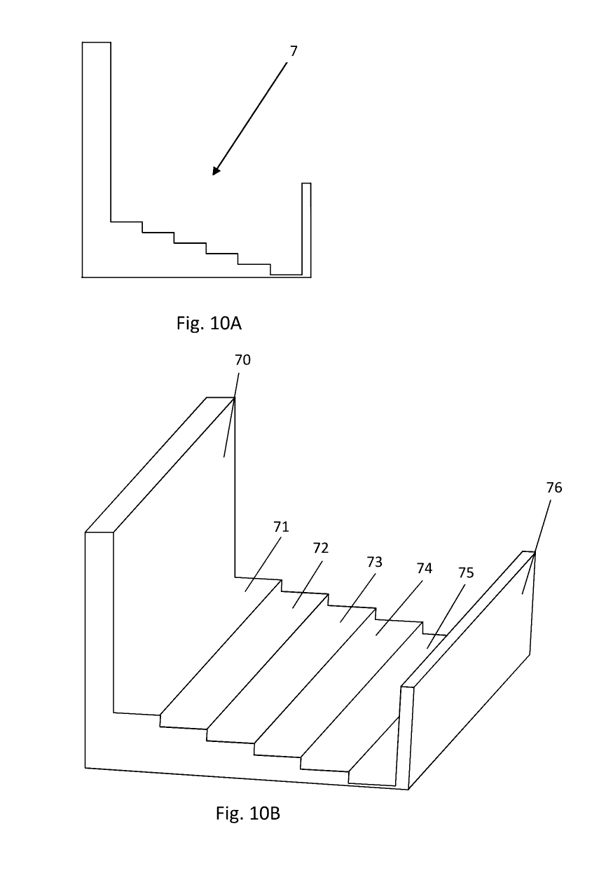

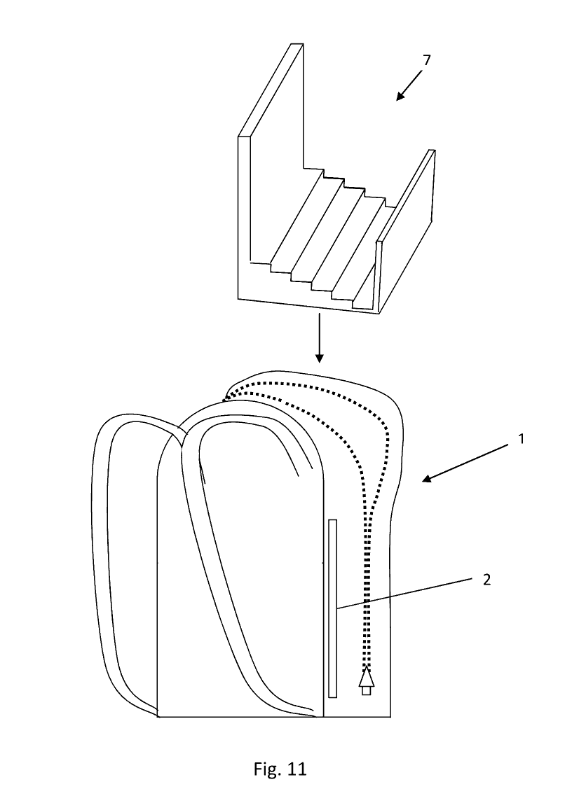

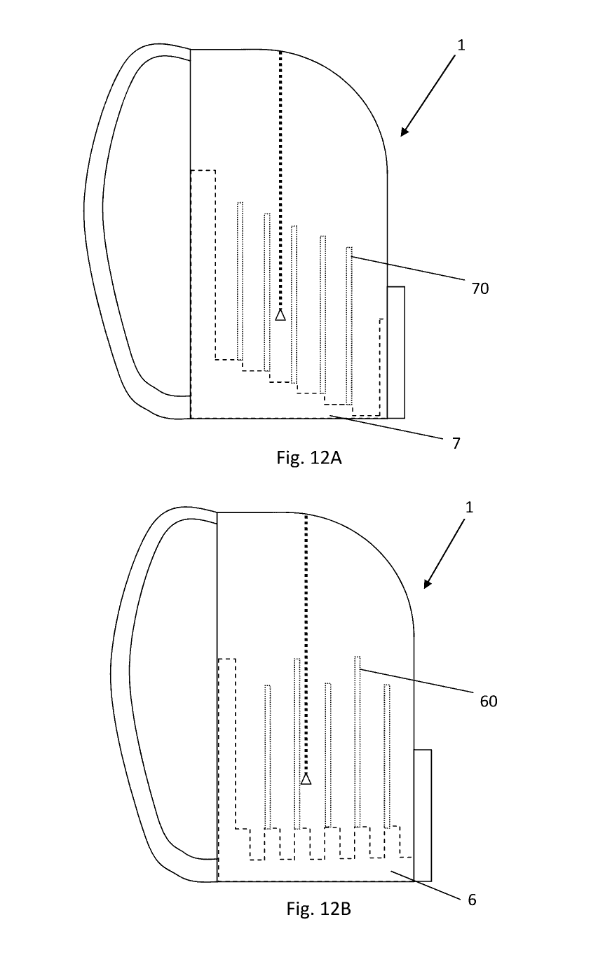

The present disclosure comprises a first matter divider body 6, wherein said first subject matter divider body 6 comprises a first wall 60, several protrusions or steps 61 and recesses 62. The space between each step 61 and recess 62 is preferred to be the same, as shown in FIG. 9A-9B. Further, the present disclosure comprises a second subject matter divider body 7, comprising a step down configuration, wherein said second subject matter divider body 7 includes a first wall 70, several steps 71-75 and a second wall 76, as shown in FIG. 10A-10B. The dividers 6, 7 are configured to be inserted inside the backpack 1, as shown in FIG. 11 through 12B. The divider 6, 7 comprises sections that are separated by subject matter separators 60, 70 representing particular subject matters.

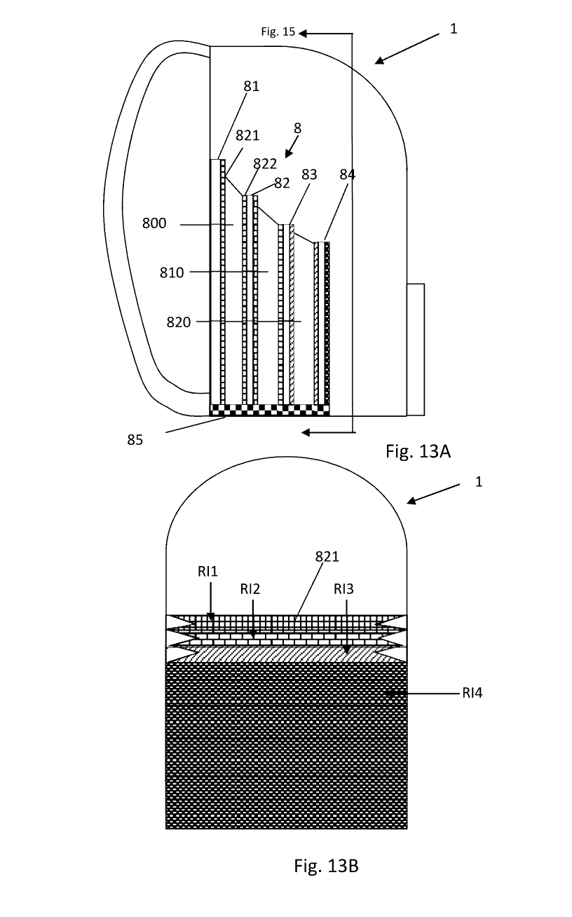

FIG. 13A-13B are general views of a flexible subject matter divider 8 exemplary embodiment inside the backpack 1 in accordance with the principles of the present disclosure. The flexible subject divider 8 comprises a plate base 85 having a series of pockets 800, 810, 820 on top, wherein each pocket comprises at least a pocket wall 81-84 working as subject matter separators. Each pocket wall 81-84 comprises a front-face 821 and a back-face 822. Further, each pocket wall 81-84 comprises recognizable indicia RI1-RI4 to allow the user to organize the articles per subject matter. It is important to understand that due to the configuration of the recognizable indicia RI1-RI4 each pocket 800, 810, 820 comprises similar recognizable indicia RI1-RI4 on the face of the pocket walls 82-84 forming the boundaries of each pocket 800, 810, 820, as shown in FIGS. 13A and 13B. For example, similar recognizable indicia RI1-RI4 is used for the wall face forming each pocket 800, 810, 820 by providing a first pocket wall front face 821 and a back-face 822 of a second pocket wall with a first recognizable indicia RI1.

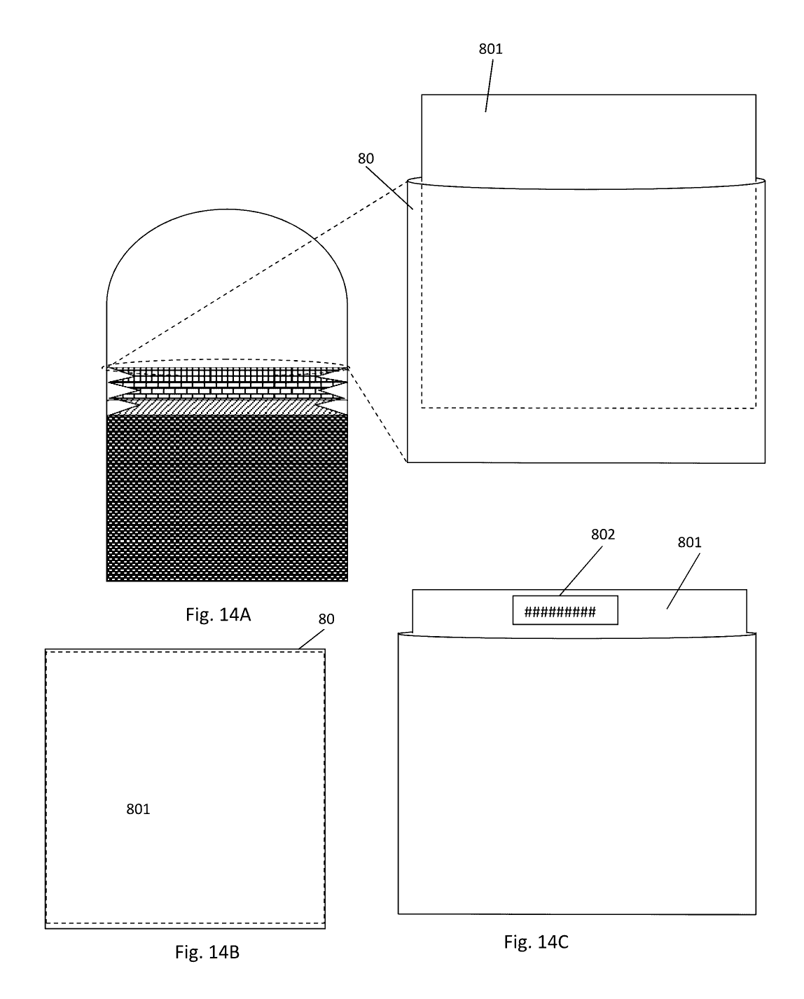

FIGS. 14A-14C are general views of the exemplary embodiment for a flexible divider including customizable interchangeable recognizable indicia 802 in accordance with the principles of the present disclosure. Each pocket wall 80 comprises a rigid inner frame 801. The inner frame 801 may extend beyond the upper pocket wall 80 limits providing a tag 801 for each pocket wall 80. The tag 801 is customized adding or covering the tags 801 with customizable indicia 802.

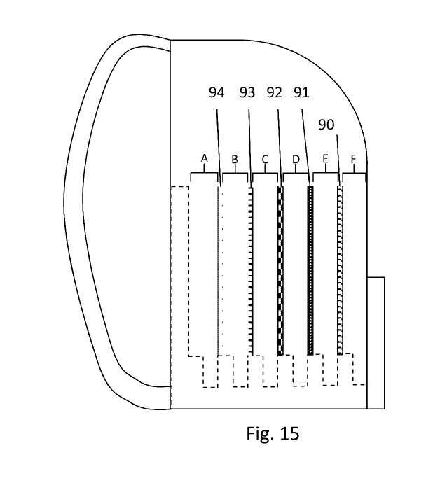

FIG. 15 is a general view of the exemplary embodiment for the subject matter divider body 6, 7 including interchangeable recognizable indicia 90-94 to allow the user to organize the articles to be transported. Particularly, the present disclosure, as shown in FIG. 15, provides a backpack 1 including subject matter divider bodies 6, 7 with separators including recognizable indicia 90-94, such as a different pattern, in order to readily organize various items by subject matter or class, allowing the student to more easily accommodate and retrieve by individual subject class materials received during the school day.

### [Electronic Characteristics]

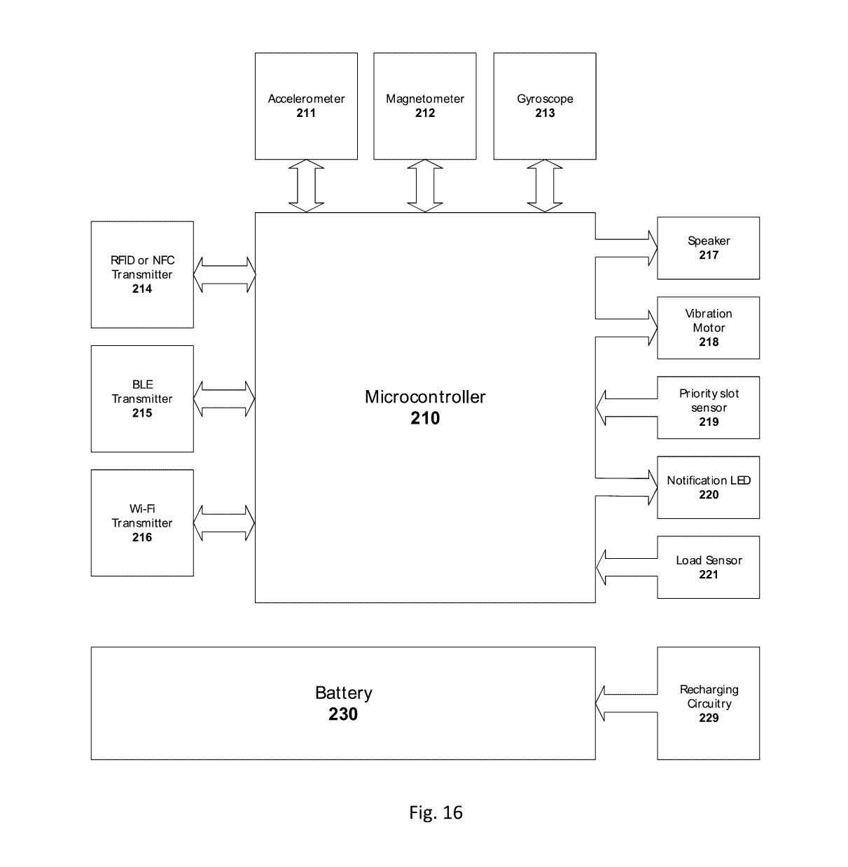

The functionalities of the backpack 1 are performed in part or wholly by a combination of hardware components with software components that work together to provide previously mentioned objects. FIG. 16, depicts the block diagram of an embodiment of the backpacks hardware component for the control unit CU. A generalized architecture of said control unit CU is presented including a microcontroller 210 which acts as the central processing unit, wherein said microcontroller 210 is electrically coupled by means of a wire or wireless to one or several components of the present disclosure. This architecture also includes a power supply 230, such as a battery, which supplies energy to all of the components. The battery 230 comprises a rechargeable circuit 229 that may allow for wireless charging, inductive charging, or cabled charging.

Additionally, the microcontroller 210 comprises several motion sensor inputs, wherein said motion sensor inputs comprise at least a magnetometer input 212, a gyroscope input 213, and an accelerometer input 211. In accordance with the principles of the present disclosure the backpack 1 uses the motion sensors to provide feedback of the user's posture with respect to the backpack. In an embodiment of the hardware architecture, the microcontroller 210 comprises a load sensor input 221 with the purpose of notifying users that a particular weight threshold has passed.

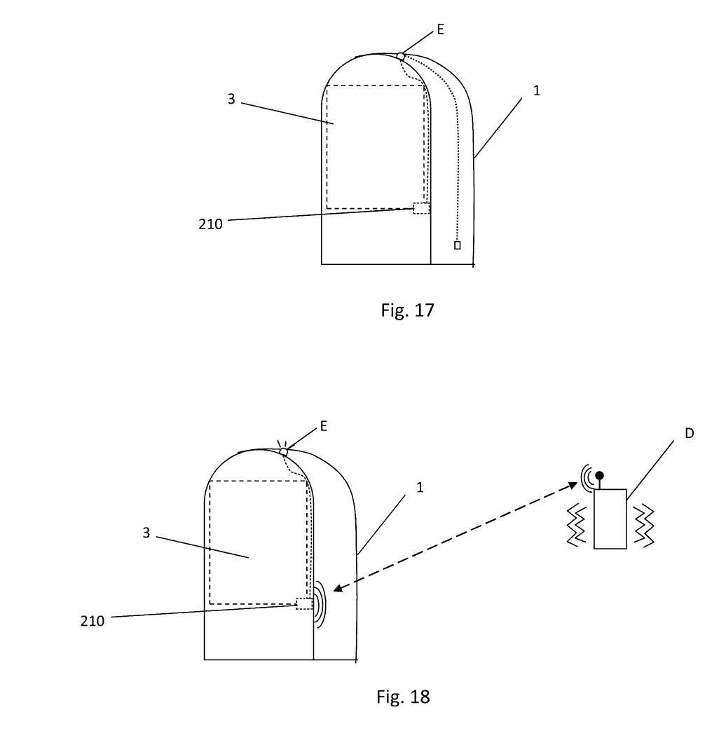

The microcontroller 210 further comprises a priority slot sensor input 219 used in combination with the priority sleeve 3 and a light emitting notification output 220 that when connected to a light emitting element visually alerts and/or notifies the user that a predefined value has been triggered, as show in FIG. 17.

It is important to understand that the microcontroller 210 includes stored data at a microcontroller database with pre-determined values. The pre-determined values include, but are not limit to the backpack's angle, backpack's position, backpack's weight, and objects near and/or away from the backpack. Reaching the pre-determined values triggers alerts in the form of light, sound or vibration. Triggering said alerts is related to the pre-determined values, wherein said pre-determined values depend on the user preference and may be adjusted by known procedures of uploading information to the microprocessor. The analysis of the received signal from the sensors and the pre-determined value is completed as part of the program at the microcontroller 210. Therefore, the microcontroller 210 comprises at least a set of instructions and/or steps to evaluate/compare the received signal from the sensor or communication technologies with the pre-determined values, wherein said received signal comprises an analog signal and/or digital signal. For example, using a mobile device D, any user may provide or transfer a first value for the pre-determined values for each of the sensors through the network communication units to the microcontroller 210, as shown in FIG. 18. The pre-determined value selected by the user is uploaded and stored at the microprocessor data base. Another example is having a pre-determined value for the weight established by the user, wherein the maximum weight to trigger the alert is 150 pounds. Similarly, the position value may be represented in terms of an angle, wherein an alert is triggered when a particular angle of the backpack is achieved.

Additionally, the microcontroller 210 comprises an audible output 217 electrically coupled to an electroacoustic device, such as a small speaker, to provide auditory stimuli for notifications and a vibration motor output 218 for coupling a vibration motor unit for physical notifications. The microcontroller may incorporate the vibration motor.

Finally, the microcontroller 210 comprises a communication transmitter/receiver units, wherein said communication transmitter/receiver units comprise a radio frequency identifier unit (RFID) 214 or a near field communication unit (NFC) 214 used for tracking objects within the backpack. A wireless networking technology unit such as a Bluetooth low energy technology (BLE) input/output 215 and a Wi-Fi input/output 216 is included to facilitate communication between the backpack 1 and a mobile computing device D. For the purposes of this application, a “mobile computing device” is to be interpreted broadly as including among others standard personal computers, smart phones, notebooks, tablets, “iPod”, “iPad”, similar Android or IOS devices, and user interface devices.

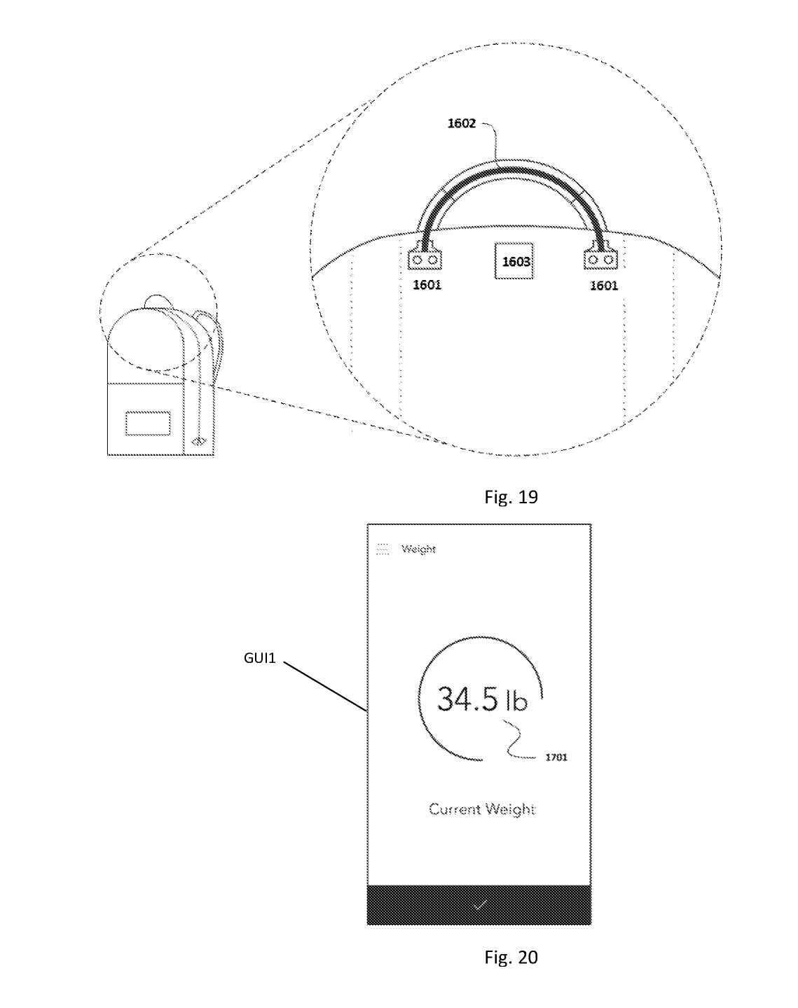

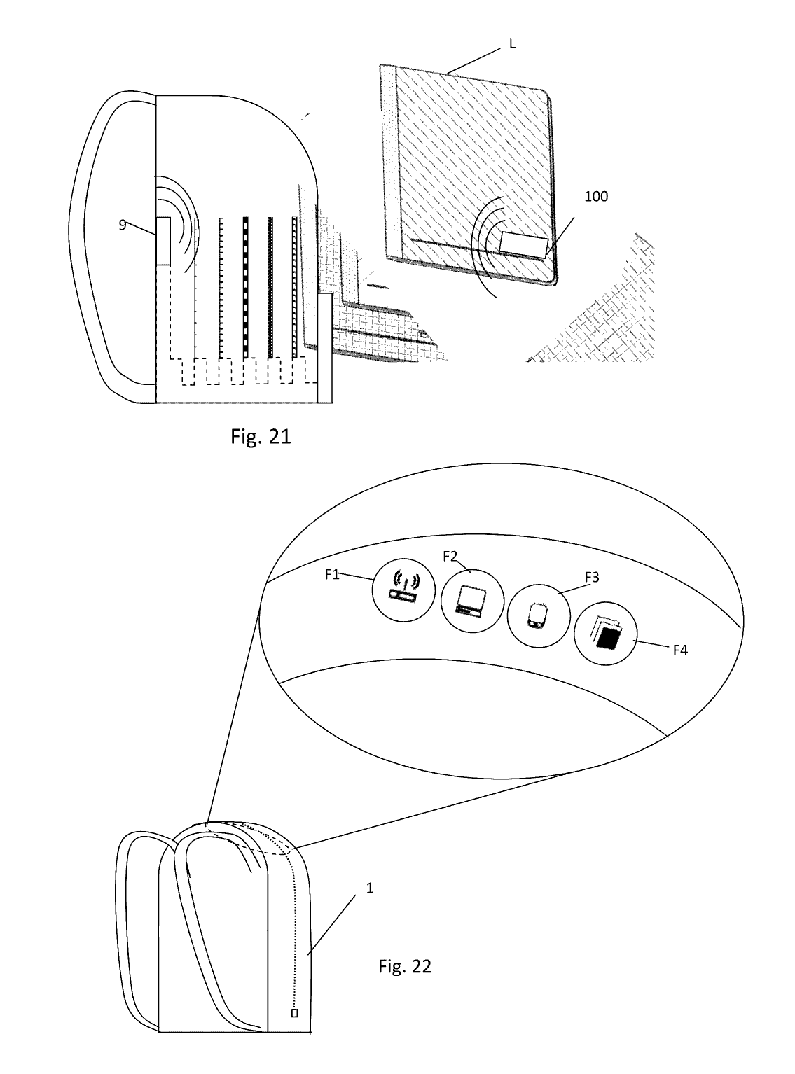

FIG. 19 is a general view of the exemplary embodiment for a weight tracking load sensor 1601 in the backpack's handle 1602 as well as the location of the posture tracking circuitry 1603. The weight tracking load sensor 1601 is electrically coupled to the load sensor input 221. The posture circuitry 1603 comprises motion sensor including at least a magnetometer, a gyroscope, and an accelerometer electrically coupled to the magnetometer input 212, the gyroscope input 213, and the accelerometer input 211 respectively. The microcontroller 210 shares information with a mobile device, as mentioned before, through at least one of the communication systems. The information is managed by the mobile device D in order to display to the user information regarding measures, such as the backpack's weight and other or features. For example, using a graphic unit (GUI) in FIG. 20, users will be able to initiate a weight scan of the backpack 1 from their mobile device D and get a weight reading 1701 by holding the backpack 1 by its handle 1602.

The posture tracking circuitry 1603 may consist of but is not limited to the accelerometer 211, magnetometer 212, and gyroscope 213, as disclosed above. Using the combined sensor data of the three or more sensors, the backpack 1 can let the user know its orientation and notify the user of improper posture as well as potentially record usage history.

FIG. 21 is directed to the exemplary embodiment for item recognition system. The backpack 1 is provided with a microcontroller 210 coupled to at least a reader/transmitter unit 9 which indicates the presence of readable unique tags 10 at a near field. Each tag 10 is assigned to a particular object such as book, notebook L or the like. The reader/transmitter 9 is configured to identify said readable tags 10 and by means of the microcontroller 210 alert the user when said object carrying the tag 10 is out of the premises of the backpack 1 or away from the reader/transmitter 9. The premises or area of cover of said reader/transmitter 9 may vary depending on the properties of said device.

For purposes of this discussion, the term “tag” 10 may include at least one of software, firmware, and hardware (such as one or more circuits, microchips, or devices, or any combination thereof), and any combination thereof. Additionally, each tag 10 may be in an active or passive configuration; that is, it may contain its own power source in the form of a battery, or it may power itself via the signals provided by the transmitter. The backpack 1 comprises indicator F1-F4 in order to indicate if any of the features is activated, such as Wi-Fi F1, mobile device connection F3, missing a priority document F2 and/or missing a book F2.

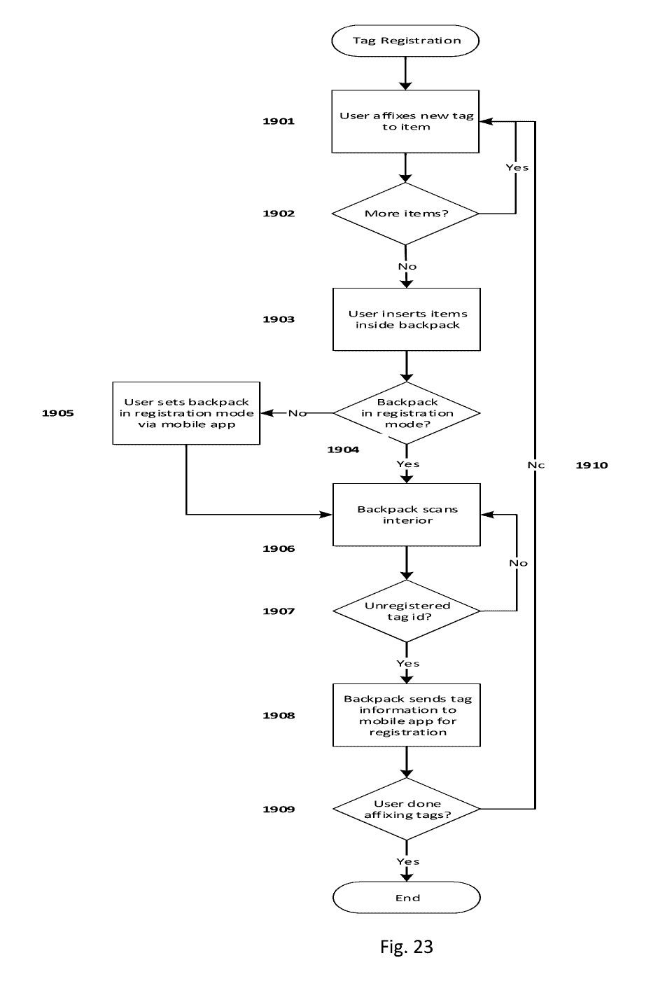

Turning to FIG. 23, a tag 10 registering logical process is shown. To register a tag 10, first preferred step 1901 a user affixes an unregistered tag 10 to an item L they wish to track. The second preferred step 1902 is directed to include or add additional elements with tags 10. If the user has more items they wish to tag they can do so all at once. In accordance with the principles of the present disclosure the next step 1903, once a user is done tagging their items, is to insert the items in the backpack 1 or at least position the tagged item at a range lesser than range pre-determined value for activating the alert due to distance between any tagged object and the receiver/transmitter 9. The user can then access the backpack's mobile software 1904 on their mobile device D and set the backpack in registration mode. 1905 During the registration mode, the backpack will automatically scan for unregistered tags. 1906 If a new tag is found 1907 the backpack 1 more particularly the microcontroller 210 sends that tags unique identification number to the mobile device 1908, and prompts the user to identify it, for example, naming it “Calculus Book.” During this process users are free to affix new tags to items and repeat the process 1909. Once all tags 10 have been registered users can simply exit the backpacks mobile software and use their backpack 1 as normal. Tags 10 and the unique identification numbers are stored at the microcontroller data base.

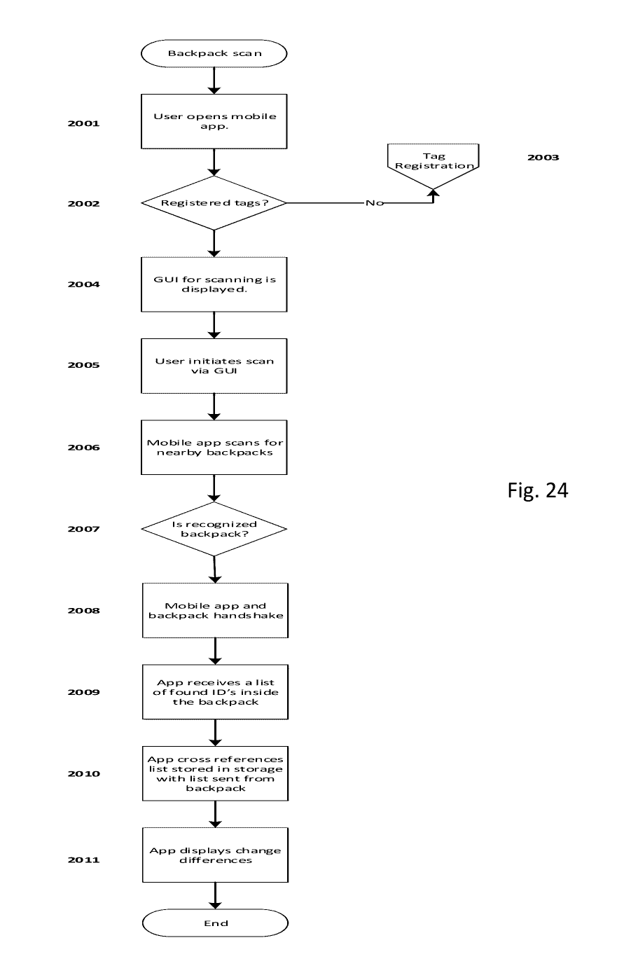

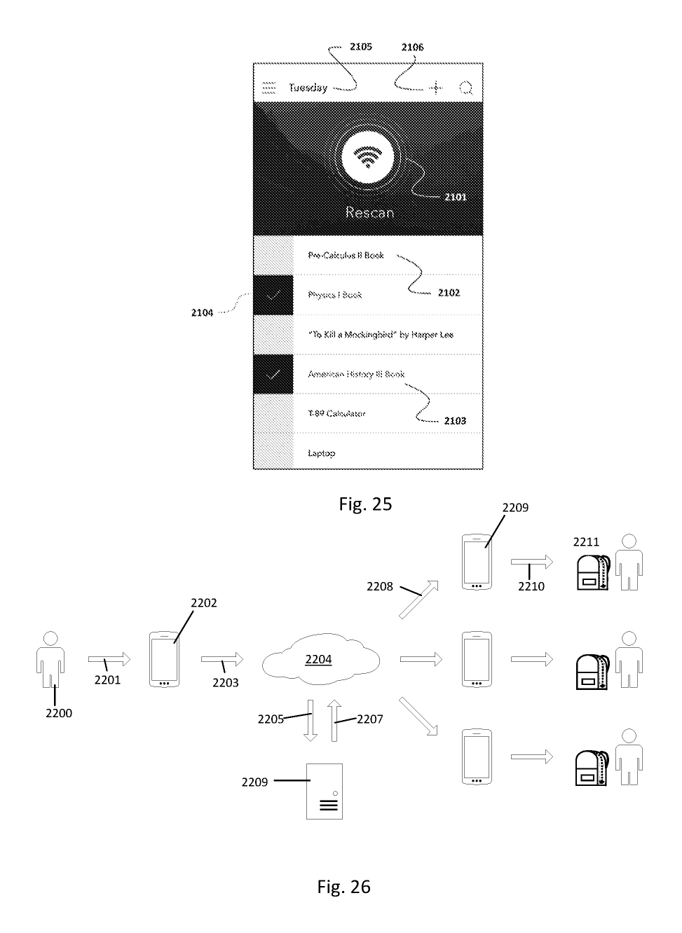

FIG. 24, depicts a logical process for scanning the items within the backpack 1. To start the backpack 1 scanning process, the user first opens the backpacks mobile software application 2001. If no tags have been registered 2002 with the backpack 1, as in the case of a new backpack, the user is automatically taken to the tag registration process 2003 seen in FIG. 23. If tags 10 have been previously registered, the mobile device program example GUI in FIG. 25 would be shown 2004. Users can then initiate scans 2005 via an input 2101 in the GUI. The mobile software would then scan for nearby backpacks, 2006 and if found, pair 2007 with a previously linked backpack. The mobile app and backpack exchange a digital handshake where a key is transferred validating that it is the correct backpack 2008. Once the backpack 1 has been verified, the mobile software for the backpack 1 requests a list of items currently stored in the backpack 2009. The mobile app then cross references 2010 the items currently contained in the backpack 1 with the ones the users has designated should be included in the backpack 1 and displays the differences between current items contained in the backpack 1 and the designated items.

Turning to FIG. 25 again, an example embodiment of what this list may look like is shown. Items that are currently missing from the backpack 2102 are shown with a visual indicator that they are missing while items that are properly contained 2103 are shown with a positive indicator 2104. If users wish to register a new tag while in this process they can simply select the input at 2106 or search through the list. The date is shown 2105 to allow users to be aware of items they need to carry for particular days of the week and to act as an entry point input to see the rest of the week days.

FIG. 26 is directed to the exemplary embodiment for an item notification system where a requester (for example, a teacher) can notify one or more backpack users (for example, students) of an item to carry. The requester 2200 can send a secured request 2201 for backpack carriers to bring a particular item for a day or series of days via a GUI on the requester's mobile device. 2202 The mobile device sends 2203 a request via the mobile phones connection to the internet 2204 to connect to a server 2205. The server 2206 will verify the requester's information and cross reference the request with the internal list of registered students for that particular requester. The server then sends individual push notifications 2207 via the internet to each student's mobile device 2208. The student's mobile device 2209 then cross-references the requesters list and finds the particular ID tag that matches that item. The mobile device then connects to the student's backpack 2211 and updates the registered tags the backpack needs to keep track off. Students would then be notified of items they need to carry for particular days. These notifications may have an expiration set by the requester.

In the present disclosure, the terms “computer program medium” and “computer-usable medium” are used to generally refer to media such as a removable storage unit or a hard disk drive. Computer program medium and computer-usable medium can also refer to memories, such as system memory and graphics memory which can be memory semiconductors (e.g., DRAMs, etc.). These products are examples of how to provide software to a computer system. The mobile devices 2202, 2209 and server 2206 are directed to computer products comprising software stored on any computer-usable medium. Such software, when executed in one or more data processing devices, causes a data processing device(s) to operate as described herein or, allows for the synthesis and/or manufacture of computing devices (e.g., ASICs, or processors) to perform embodiments described herein. Embodiments employ any computer-usable or -readable medium, and any computer-usable or -readable storage medium known now or in the future. Examples of computer-usable or computer-readable mediums may include, but are not limited to, primary storage devices (e.g., any type of random access memory or read-only memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

In addition, it will be understood that each module may include one or more components within an actual device, and each component that forms a part of the described module can function either cooperatively or independently of any other component forming a part of the module. Conversely, multiple modules described herein may represent a single component within an actual device. Further, components within a module may be in a single device or distributed among multiple devices in a wired or wireless manner.

Although the embodiments disclosed herein may include a particular network configuration, embodiments of the present disclosure may be implemented in a variety of data communication network environments using software, hardware, or a combination of hardware and software to provide the processing functions.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

1. A backpack comprising:
a main storage compartment having a first opening and a bottom;
a closing mechanism, wherein said closing mechanism limits the access to the main storage compartment;
a priority pocket, wherein said priority pocket comprises a first open space and a second opening;
wherein said priority pocket comprises at least a first slide-out sleeve; and
wherein said slide-out sleeve comprises at least a pocket section.

2. The backpack according to claim 1 wherein said pocket section comprises a first sensor, wherein said first sensor generates an electronic signal at the presence of a document inside said pocket section.

3. The backpack according to claim 2 comprises a visual alert indicator; wherein said visual alert indicator is electrically coupled to said first sensor; and wherein said visual alert generates a visual sign from said electronic signal.

4. The backpack according to claim 1 wherein said pocket section comprises slide-out mechanism, wherein said slide-out mechanism comprises a guide that assist with the pocket section movement away from the first open space.

5. The backpack according to claim 1 wherein said main storage compartment comprises a first matter divider, wherein said first matter divider comprises a plurality of sections, wherein said section is identified with interchangeable recognizable indicia.

6. The backpack according to claim 5, wherein said first divider comprises a first wall; wherein said each section of said plurality of sections comprises a first bottom, wherein said first bottom comprises at least a protrusion and a recess.

7. The backpack according to claim 5, wherein said first divider comprises a first wall; wherein said plurality of sections comprises at least a first section including a first bottom and at least a second section including a second bottom, wherein said first bottom is located at a higher position than said second bottom with respect to the bottom.

8. The backpack according to claim 5, wherein said first divider comprises a flexible subject divider.

9. The backpack according to claim 1 further comprising a control unit, wherein said control unit comprises a microcontroller and a database.

10. The backpack according to claim 9, wherein said microcontroller comprises motion sensors.

11. The backpack according to claim 9 further comprising a handle, wherein said handle comprises a weight tracking load sensor.

12. The backpack according to claim 9 further comprising a posture circuitry, wherein said posture circuitry is electronically coupled to said microcontroller.

13. The backpack according to claim 9 further comprising an item recognition system, wherein said item recognition system comprises at least one unique readable tag and a reader/transmitter unit; and wherein said item recognition system is electronically coupled to said microcontroller, and wherein said microcontroller comprises a software, wherein said software completes a previous reading, wherein said previous reading activates the reader reader/transmitter unit and identifies the unique readable tags inside the storage compartment; and wherein said previous reading is stored in said database.

14. The backpack according to claim 13 wherein said software completes a first reading, wherein said first reading activates the reader reader/transmitter unit and identifies the unique readable tags inside the storage compartment and compare said first reading with said previous reading.
